(19) United States
(12) Patent Application Publication
(10) Pub. No.: US 2019/0123980 A1
(43) Pub. Date: Apr. 25, 2019

(54) METHOD AND SYSTEM FOR FACILITATING REAL-TIME DATA AVAILABILITY IN ENTERPRISES

(71) Applicant: Wipro Limited, Bangalore (IN)

(72) Inventors: Harendra Singh, Bangalore (IN); Vipin Talodil Radhakrishnan, Bangalore (IN)

(21) Appl. No.: 15/837,765

(22) Filed: Dec. 11, 2017

(30) Foreign Application Priority Data
Oct. 25, 2017 (IN) 201741037792

(51) Int. Cl. H04L 12/26; H04L 29/08

(52) U.S. Cl. CPC H04L 43/04; H04L 67/306

(57) ABSTRACT

The present disclosure relates to method and system for facilitating real-time data availability in enterprises by a data management system. The data management system comprises receiving user data associated with an enterprise from a user, performing a first level of validation of the user data based on pre-defined data governance standards of the enterprise, performing a second level of validation of the first level validated user data, based on pre-defined data integrity rules and taxonomy rules and standards, associated with the enterprise, uploading the second level validated user data on a customer relation management database associated with the enterprise and validating the uploaded data based on the pre-defined data governance standards, the data integrity rules, the taxonomy rules, and the standards associated with the enterprise, to facilitate real-time data availability in the enterprise. The present disclose facilitates efficient real-time data import and availability without performing any synchronization procedure.

This application claims the benefit of Indian Patent Application Serial No. 2017/41037792 filed Oct. 25, 2017 which is hereby incorporated by reference in its entirety.

### FIELD

The present subject matter is related in general to the field of data management, more particularly, but not exclusively to method and system for facilitating real-time data availability in enterprises.

### BACKGROUND

Digital revolution in data storage, collection, dissemination and the like have resulted in enterprises acquiring massive amounts of customer information. As a consequence, the enterprises are increasingly being confronted with huge amount of data stored in inconsistent databases. Thus, the storage, the collection and appropriate use of such data is a major challenge for enterprises, as they struggle to implement profitable strategies. Hence, identification of processes is required which may not only capture customer data, increase customer knowledge but also maintain and facilitate data availability in real-time.

Today most of the existing systems makes use of Customer Relationship Management (CRM) systems which are designed to compile information on customers across different aspects. The CRM system is related to processes, systems and technologies for managing and analysing data and customer interactions throughout the lifecycle of customer for improving business relationships with customers and driving sales growth. Data import function allows user to upload data into standard and customized format from various customer relationship management systems. Generally, the activity of real-time data loading onto CRM systems is complicated due to limited functionalities available in current applications. In the existing system, the data that is provided by the user for uploading in the CRM systems may endure a delay for instance, for 2 hours, 4 hours or more. The delay may be caused as the data that is being uploaded is moved into a server which runs a package containing the uploaded data as a scheduled task, which runs only at a predefined time. Hence, the data uploaded by the user would be reflected in the CRM systems only after the package has been run. As a result, there is non-availability of real-time data during business operations. This may lead to costly errors and stall the progress of the business operation. Therefore, there is a need for a system to address the problem of real-time data import and availability which arises due to non-reflection of data immediately after the data has been uploaded.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for facilitating real-time data availability in enterprises. The method comprises receiving user data associated with an enterprise from a user, performing a first level of validation of the user data based on pre-defined data governance standards of the enterprise, performing a second level of validation of the first level validated user data, based on pre-defined data integrity rules and taxonomy rules and standards, associated with the enterprise, uploading the second level validated user data on a customer relation management database associated with the enterprise and validating the uploaded data based on the pre-defined data governance standards, the data integrity rules, the taxonomy rules, and the standards associated with the enterprise, to facilitate real-time data availability in the enterprise.

In an embodiment, the present disclosure relates to a data management system for facilitating real-time data availability in enterprises. The data management system comprises a processor and a memory communicatively coupled to the processor, where the memory data management system to receiving user data associated with an enterprise from a user, performing a first level of validation of the user data based on pre-defined data governance standards of the enterprise, performing a second level of validation of the first level validated user data, based on pre-defined data integrity rules and taxonomy rules and standards, associated with the enterprise, uploading the second level validated user data on a customer relation management database associated with the enterprise and validating the uploaded data based on the pre-defined data governance standards, the data integrity rules, the taxonomy rules, and the standards associated with the enterprise, to facilitate real-time data availability in the enterprise.

In an embodiment, the present disclosure relates to a non-transitory computer readable medium including instructions stored thereon that when processed by at least one processor may cause a data management system to receive user data associated with an enterprise from a user, performing a first level of validation of the user data based on pre-defined data governance standards of the enterprise, perform a second level of validation of the first level validated user data, based on pre-defined data integrity rules and taxonomy rules and standards, associated with the enterprise, upload the second level validated user data on a customer relation management database associated with the enterprise and validate the uploaded data based on the pre-defined data governance standards, the data integrity rules, the taxonomy rules, and the standards associated with the enterprise, to facilitate real-time data availability in the enterprise.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for facilitating real-time data availability in enterprises in accordance with some embodiments of the present disclosure;

FIG. 2a shows a detailed block diagram of a data management system in accordance with some embodiments of the present disclosure;

FIG. 2b shows an exemplary representation of a service request template in accordance with some embodiments of present disclosure;

FIG. 3 illustrates a flowchart showing a method for facilitating real-time data availability in enterprises in accordance with some embodiments of present disclosure;

FIG. 4 show exemplary representation for facilitating real-time data availability in bank enterprise in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method and a data management system for facilitating data availability in enterprises. In an embodiment, the data may be uploaded in a Customer Relation Management (CRM) database to which an enterprise may be connected. In an embodiment, the data management system may be connected to an on-premise and on-demand CRM system. Whenever data needs to be updated in the CRM database associated with the enterprise, the data management system may receive data from users. The received user data may be processed and validated at two levels namely first level and second level to check compliance with pre-defined data governance rules, data integrity rules and taxonomy rules and standards associated with the enterprise. The validated user data which satisfy the two-level of validation may be uploaded into the CRM database. Post updating, the uploaded user data may be validated based on the pre-defined data governance rules, the data integrity rules and the taxonomy rules and standards to facilitate real-time data availability in the enterprise. In an embodiment, the user may be notified of failures that have occurred during validation of the user data using a transaction summary report. The present disclose facilitates efficient real-time data import and availability. A post-import data reflection validation may be performed which enables traceability of data uploads. In the present disclosure, data uploading and facilitating takes place in real-time, thereby eliminating the requirement of performing a synchronization procedure.

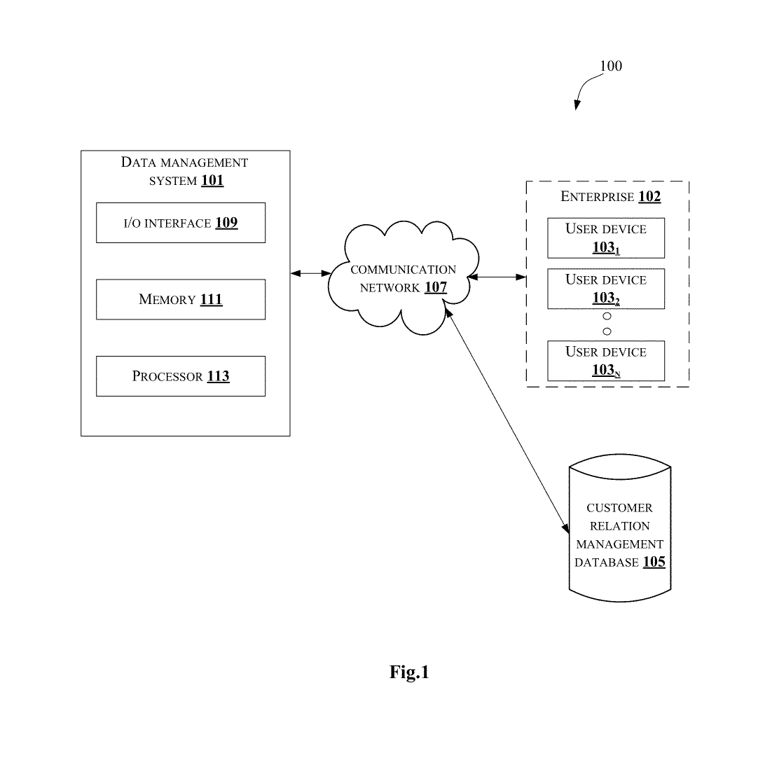

FIG. 1 illustrates an exemplary environment for facilitating real-time data availability in enterprises in accordance with some embodiments of the present disclosure.

As shown in FIG. 1, the environment 100 includes a data management system 101 connected through a communication network 107 to a user device 1031, a user device 1032, .and a user device 103N (collectively referred as user devices 103) associated with users of an enterprise 102 and a Customer Relation Management (CRM) database 105 associated with the enterprise 102. In an embodiment, the enterprise 102 may refer to an entity which may use computers and may encompass corporations, small businesses, non-profit institutions, government bodies, and any other kind of organizations. In an embodiment, the CRM database 105 may be associated with a Customer Relation Management (CRM) system to which the enterprise 102 may be connected (not shown explicitly in FIG. 1). The CRM system may help the enterprise 102 in determining needs and preferences of their customers by managing, organizing, tracking and storing all customer interactions in the CRM database 105. In an embodiment, the such as, operational CRM system, analytical CRM system, collaborative CRM system and the like. A person skilled in the art would understand that the enterprise 102 may be connected to any other CRM system, not mentioned explicitly in the present disclosure. In an embodiment, the user devices 103 may include, but is not limited to, a laptop, a desktop computer, a Personal Digital Assistant (PDA), a notebook, a smartphone, a tablet, a server and any other computing devices. A person skilled in the art would understand that, any other devices, not mentioned explicitly, may also be used in the present disclosure. Further, the communication network 107 may include, but is not limited to, a direct interconnection, an e-commerce network, a Peer to Peer (P2P) network, Local Area Network (LAN), Wide Area Network (WAN), wireless network (e.g., using Wireless Application Protocol), Internet, Wi-Fi and the like. The data management system 101 may facilitate real-time data availability in the enterprise 102.

Initially, when users associated with the enterprise 102 require uploading of data in the CRM database 105, user data may be received by the data management system 101 from the user devices 103. In an embodiment, the user data may be received in a service request template such as, ExcelR sheets, WordR document and other template formats in which the user data may be received. The service request template may include at least one of mandatory fields or optional fields to be filed by the users. For example, the mandatory fields may include “name”, “contact”, “date of birth” and the like. In an embodiment, the mandatory fields and the optional fields may vary depending on requirements of enterprises. On receiving the user data in the service request template, the data management system 101 may perform a first level of validation of the user data. The first level of the validation may be performed based on pre-defined data governance standards associated with the enterprise 102. In an embodiment, the pre-defined data governance standards may include, completeness check, conformity check, field duplicate check or reference check. A person skilled in the art would understand that any other checks, not mentioned explicitly, may also be used in the present disclosure. In an embodiment, the user data which may fail the first level of validated based on the pre-defined data governance standards may be removed from the user data and an error may be registered against the failed user data along with error description. The failed user data may be stored in the data management system 101. For the user data which passes the first level of validation, the data management system 101 may perform a second level of validation. The second level of the validation may be performed based on pre-defined data integrity rules and taxonomy rules and standards associated with the enterprise 102. In an embodiment, the pre-defined data integrity rules and taxonomy rules and standards may include system integrity check, de-duplicate check or user access check. A person skilled in the art would understand that any other check, not mentioned explicitly may also be included in the present disclosure. In an embodiment, the user data which passes the first level of validation, but fails the second level of validation may be removed and an error may be registered against the failed second level of validated user data along with corresponding error description. In an embodiment, the failed second level of validated user data may be stored in the data management system 101. Further, the data management system 101 may upload the first and the second level of validated user data in the CRM database 105 associated with the enterprise 102. Post uploading, the data management system 101 may validate the uploaded data based on the pre-defined data governance standards, the data integrity rules, the taxonomy rules and standards. In an embodiment, validating the uploaded data may comprise a reflection check. The reflection check may ensure that the user data is uploaded into correct entities and is in compliance with rules of CRM database 105 associated with the enterprise 102. In an embodiment, the validation of the uploaded data may include verifying if the uploaded data is reflected correctly in the CRM database 105. In an embodiment, the data management system 101 may perform a rollback operation on the uploaded data on identifying one or more anomalies in the uploaded data based on post uploading validation. Further, once the user data is uploaded, the data management system 101 may generate a transaction summary report detailing about status of the user data uploaded in the CRM database 105 and the user data which may have failed at least one of the first level validation, the second level of validation or the uploaded data validation along with error descriptions. The present disclosure may facilitate efficient real-time data import and availability. A post-import data reflection validation may be performed which enables traceability of data uploads.

The data management system 101 may include an I/O Interface 109, a memory 111 and a processor 113. The I/O interface 109 may be configured to receive user data from the users associated with the enterprise 102. The I/O interface 109 may provide the transaction summary report to the users associated with the user data.

The information received from the I/O interface 109 may be stored in the memory 111. The memory 111 may be communicatively coupled to the processor 113 of the data management system 101. The memory 111 may also store processor instructions which may cause the processor 113 to execute the instructions for facilitating real-time data availability in the enterprises.

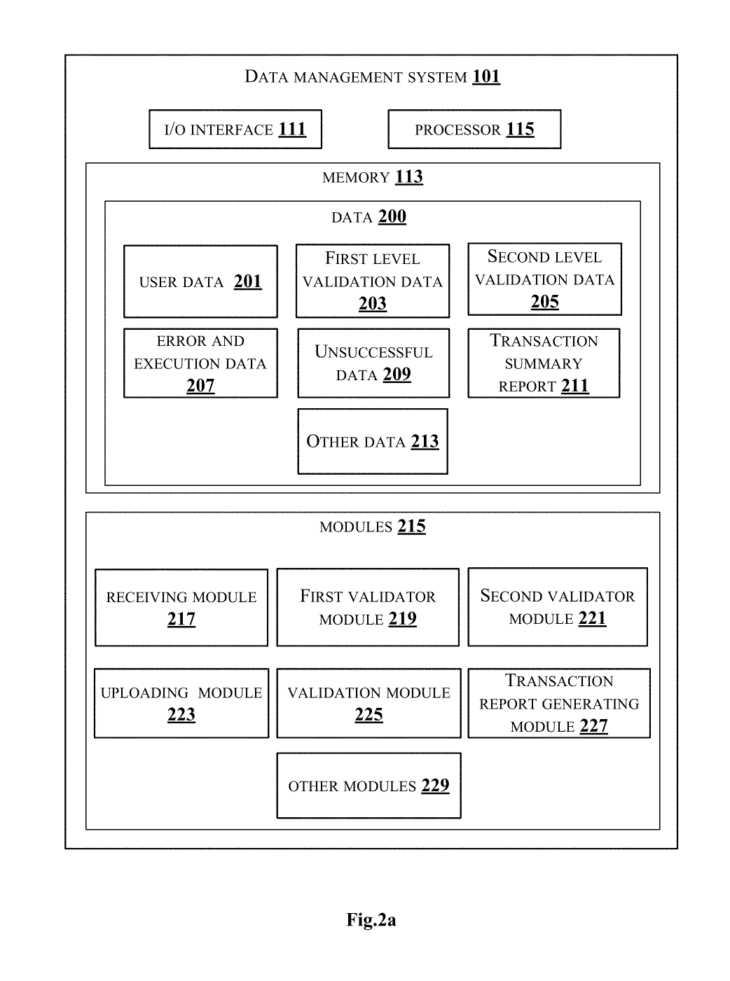

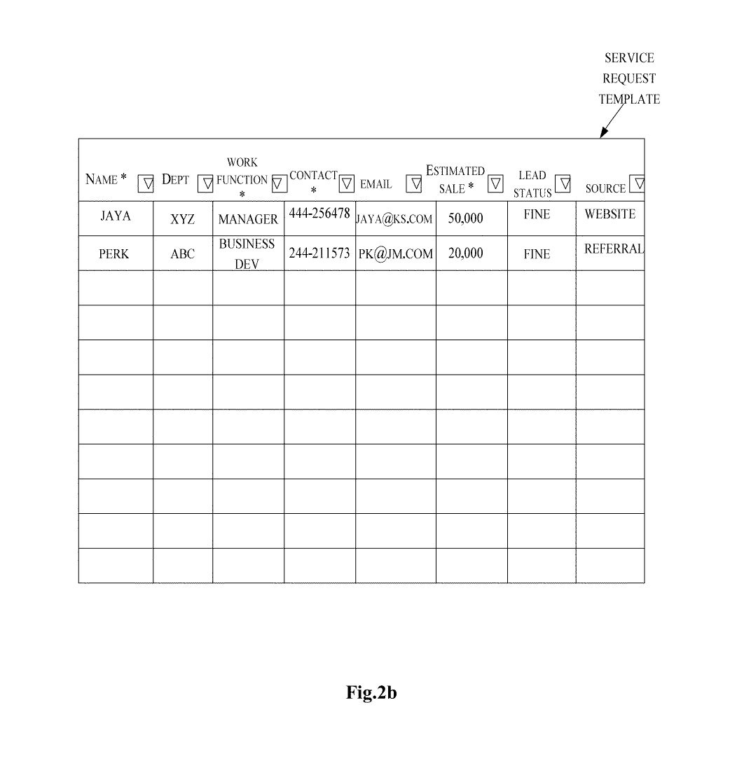

FIG. 2a shows a detailed block diagram of a data management system in accordance with some embodiments of the present disclosure.

Data 200 and one or more modules 215 of the data management system 101 are described herein in detail. In an embodiment, the data 200 may include user data 201, first level validation data 203, second level validation data 205, error and execution data 207, unsuccessful data 209, transaction summary report 211 and other data 213.

The user data 201 may include data which the users may need to upload in the CRM database 105. The user data 201 may be provided by the users in the service request template format based on the requirement of the enterprise 102. In an embodiment, the service request template may comprise at least one of mandatory fields or optional fields. For example, mandatory fields may include “name”, “contact” and the like. In an embodiment, the mandatory field may include an asterisk symbol (*) indicating a compulsory requirement.

The first level validation data 203 may include details associated with the pre-defined data governance standards associated with the enterprise 102. In an embodiment, the pre-defined data governance standards may include at least one of, completeness check, conformity check, field duplicate check or reference check. A person skilled in the art would understand that any other governance checks, not mentioned explicitly may also be included in the present disclosure.

The second level validation data 205 may include details associated with the pre-defined data integrity rules, the taxonomy rules and standards. In an embodiment, the pre-defined data integrity rules and the taxonomy rules and standards may include at least one of the system integrity check, the de-duplicate check and the user access check.

The error and execution data 207 may include a record detailing the status of validation of the user data. The record may include the error descriptions generated for the user data which may have failed during validation. The record may also include execution record for the user data which may be successfully validated.

The unsuccessful data 209 may include the user data which failed during the validations. The failed user data may be removed from the user data and stored in the unsuccessful data 209. The unsuccessful data 209 may comprise the user data which is not validated based on the first level of validation and removed from the user data. The unsuccessful data 209 may also comprise the user data which is not validated based on the second level of validation and removed from the user data.

The transaction summary report 211 may include the status of the user data uploaded in the CRM database 105 and the user data which may have failed at least one of the first level of validation, the second level of validation or the uploaded data validation, along with error descriptions.

The other data 213 may store data, including temporary data and temporary files, generated by modules 215 for performing the various functions of the data management system 101.

In an embodiment, the data 200 in the memory 111 are processed by the one or more modules 215 of the data management system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules 215 when configured with the functionality defined in the present disclosure will result in a novel hardware.

In one implementation, the one or more modules 215 may include, but are not limited to a receiving module 217, a first validator module 219, a second validator module 221, an uploading module 223, a validation module 225 and a transaction report generating module 227. The one or more modules 215 may also include other modules 229 to perform various miscellaneous functionalities of the data management system 101. In an embodiment, the other modules 229 may include a failed record module which may record the user data which may be failed during validation.

The receiving module 217 may receive the user data 201 to be uploaded in the CRM database 105, from the users associated with the enterprise 102. The user data 201 may be received in the service request template from the user. For example, the service request template may be ExcelR sheet template. FIG. 2b shows an exemplary representation of a service request template in accordance with some embodiments of present disclosure. As shown in FIG. 2b, one or more fields are provided to be entered data by the user. The fields present may be mandatory or optional based on the requirement of the enterprise 102.

The first validator module 219 may validate the user data 201 received from the users in the service request template. The first validator module 219 may validate the user data 201 based on the pre-defined data governance standards associated with the enterprise 102. In an embodiment, the pre-defined data governance standards may include at least one of, completeness check, conformity check, field duplicate check or reference check. The first validator module 219 may perform the completeness check by conforming if all the mandatory fields in the received user data 201 are populated. The conformity check may be performed by checking if the values populated in the user data 201 adheres to the standards of the

CRM system to which the enterprise 102 may be connected. The field duplicate check may be performed by checking if any duplicate fields are present in the user data 201 and the reference check may be performed to check dependencies of the user data 201 in one or more fields from preceding fields. In an embodiment, the user data 201 which is successfully validated may be sent to the second validator module 221. The first validator module 219 may move the user data 201 which is not validated to the unsuccessful data 209.

The second validator module 221 may perform a validation on the first level of validated user data. The second validator module 221 may validate the first level of validated user data based on the pre-defined data integrity rules and the taxonomy rules and standards. In an embodiment, the pre-defined data integrity rules and the taxonomy rules and standards may include at least one of the system integrity check, the de-duplicate check and the user access check. The second validator module 221 may perform the system integrity, for example, when creating an account, it is mandatory to provide contact details for that account. The system integrity check may be performed to enforce the users to provide contact details and associate the same with the newly created account. The second validator module 221 may perform the de-duplicate check by checking if any duplicate values are present in the first level of validated user data. In the de-duplication check, for example, while creating an account, a check may be performed in real-time, if there are any entry of duplicate values in the system. The user access check may be performed by checking all users control and the right level of execution. For instance, all users may not have access to perform all the operations on the CRM database 105.

The uploading module 223 may upload the first and the second level of validated user data in the CRM database 105.

The validation module 225 may validate the uploaded data based on the pre-defined data governance standards, the data integrity rules, the taxonomy rules, and the standards associated with the enterprise 102, to facilitate real-time data availability in the enterprise 102. In an embodiment, the validation module 225 may validate whether the uploaded data is reflected correctly in the CRM database 105. In an embodiment, the validation module 225 may perform the rollback operation on the uploaded data on identifying one or more anomalies in the uploaded data. The validation module 225 may perform the rollback operation by using a staging table which keeps a “AS-IS” copy of the user data which may be manipulated every time an update is performed.

The transaction report generating module 227 may generate a transaction summary report 211 for the users. The translation summary report may comprise a status of the user data uploaded in the CRM database 105 and the user data which failed at least one of the first level of validation, the second level of validation or the uploaded data validation, along with error descriptions.

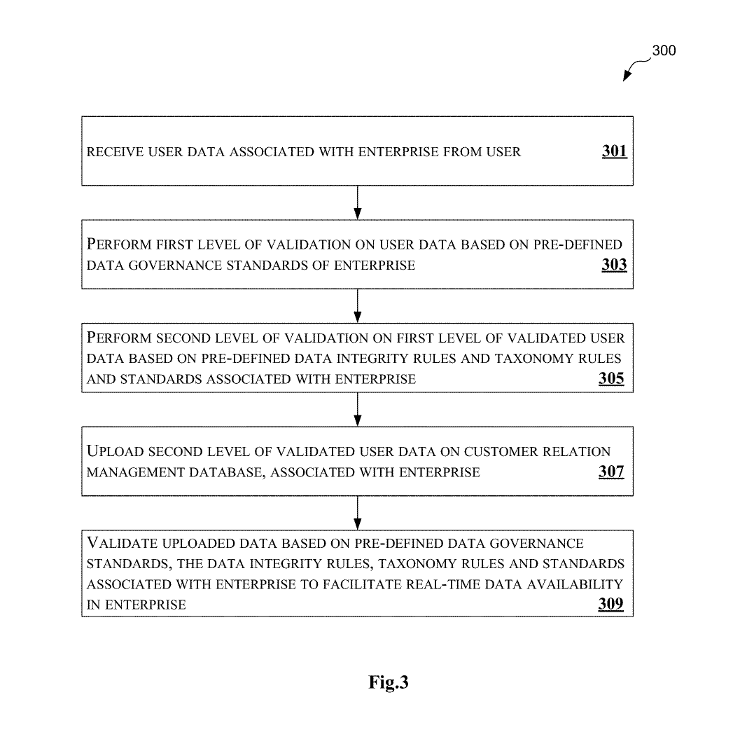

FIG. 3 illustrates a flowchart showing a method for facilitating real-time data availability in enterprise in accordance with some embodiments of present disclosure.

As illustrated in FIG. 3, the method 300 includes one or more blocks for facilitating real-time data availability in enterprises. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof

At block 301, user data associated with the enterprise 102 may be received by the receiving module 217 from the user. In an embodiment, the user data may be received in the service request template, where the said service request template comprises at least one of mandatory fields and the optional fields.

At block 303, the first level of validation of the user data may be performed by the first validator module 219 based on the pre-defined data governance standards of the enterprise 102.

At block 305, the second level of validation of the first level validated data may be performed by the second validator module 221 based on the pre-defined data integrity rules and taxonomy rules and standards associated with the enterprise 102.

At block 307, the first and the second level validated user data may be uploaded by the uploading module 223 on the CRM database 105 associated with the enterprise 102.

At block 309, the uploaded data may be validated by the validation module 225 based on the pre-defined data governance standards, the data integrity rules, the taxonomy rules and standards associated with the enterprise 102 to facilitate real-time data availability in the enterprise 102.

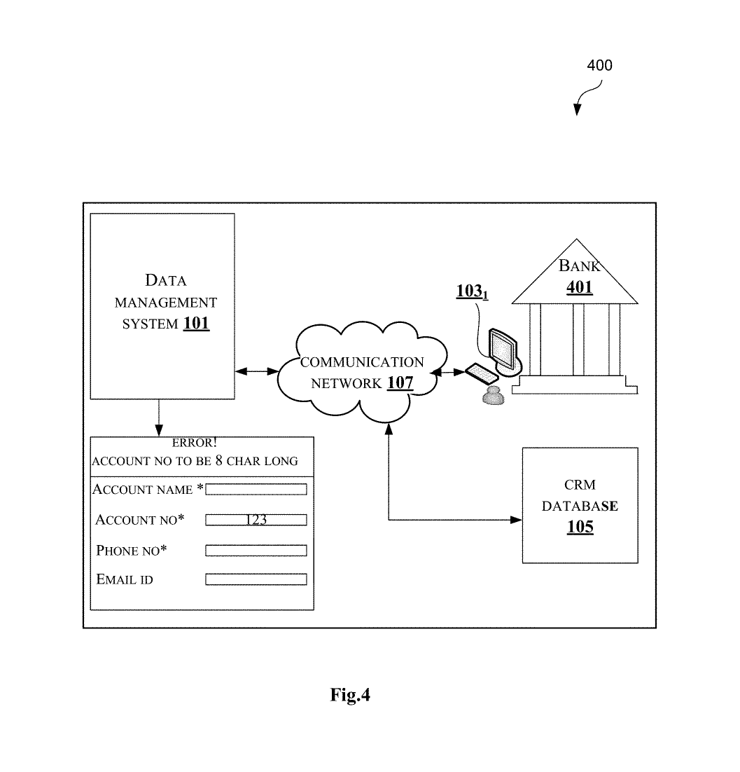

FIG. 4 show exemplary representations for facilitating real-time data availability in a bank in accordance with some embodiments of the present disclosure.

As shown in FIG. 4, the environment 400 illustrates a scenario of facilitating real-time data availability associated with a bank enterprise in an exemplary embodiment of the present disclosure. The environment 400 illustrates the data management system 101 connected to a banking enterprise (bank) 401 and the CRM database 105 through the communication network 107. A person skilled in the art would understand that FIG. 4 is an exemplary embodiment and the enterprise may also include other enterprises. The banking enterprise 401 may be associated with the CRM database 105. As shown in FIG. 4, a user associated with the banking enterprise 401 may send account creation data through service request template from the user device 103 for uploading. The data management system 101 may receive the bulk account creation data and perform the first level of validation based on the pre-defined data governance standards associated with the banking enterprise 401. In an embodiment, the pre-defined governance standards may include completeness check, conformity check, field duplicate check and/or a reference check. The completeness check may include checking, for example, if account details associated with each mandatory field is entered and complete. The conformity check may include, for example, checking format of account number associated with accounts and the like. As shown in FIG. 4, account number is entered as “123” for which an error in account creation page is displayed as “Error! Account number should be 8 characters long”. Once the first level validation is performed, the data management system 101 may perform the second level of validation of the first level of the plurality of account creation data based on the pre-defined data integrity rules, taxonomy rules and standards. In an embodiment, the pre-defined data integrity rules, taxonomy rules and standards may include the system integrity check, the de-duplicate check and the user access check. In an embodiment, the second level of validation in the banking enterprise 401 may enforce and check presence of one or more essential information such as, PAN number, Aadhar number, phone number, email address and the like associated with users to make the account complete and usable by the banking enterprise 401. On validating the second level of validated user account creation data, the data management system 101 may upload verified account creation data on the CRM database 105. Post uploading, the data management system 101 may validate the uploaded data based on the pre-defined governance standards and the pre-defined data integrity rules, taxonomy rules and standards. In an embodiment, the validation of the uploaded account creation data may be performed to verify if the uploaded account creation data is reflected correctly in the CRM database 105. In an embodiment, the data management system 101 may generate a transaction summary detailing about the status of the account creation data uploaded in the CRM database 105 and account creation data which failed at least one of the first level validation, the second level of validation or the uploaded data validation along with error descriptions.

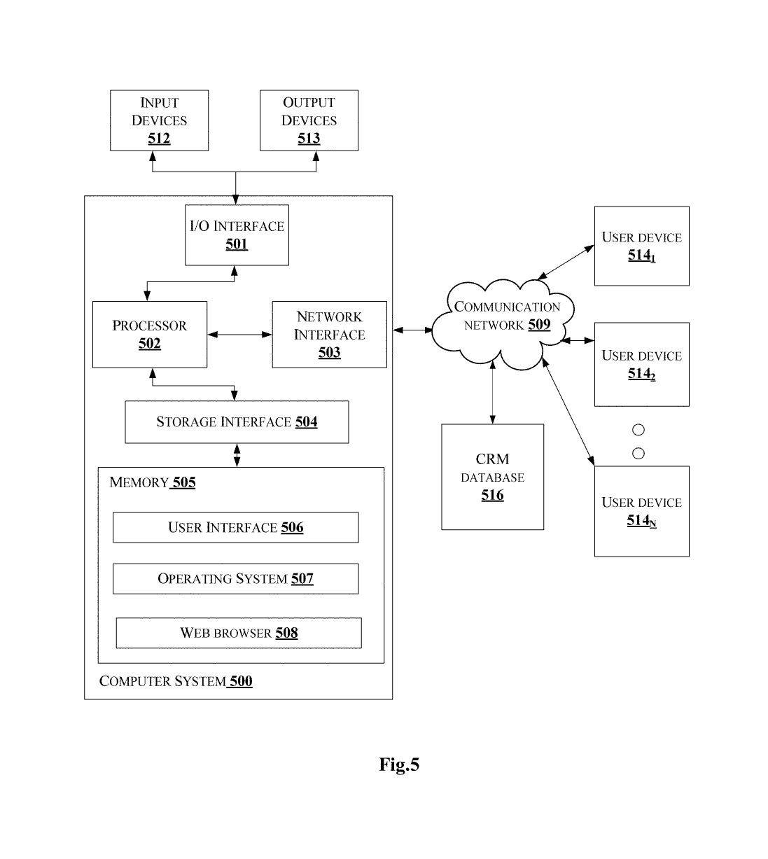

FIG. 5 illustrates a block diagram of an exemplary computer system 500 for implementing embodiments consistent with the present disclosure. In an embodiment, the computer system 500 may be used to implement the data management system 101. The computer system 500 may include a central processing unit (“CPU” or “processor”) 502. The processor 502 may include at least one data processor for facilitating real-time data availability in enterprises. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of a data management system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802. 11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with a user device 5141, a user device 5142, a user device 514N associated and a CRM database 516. The computer system 500 is connected to a service provider server 517. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE MACINTOSHR OS X, UNIXR, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLER IOS™, GOOGLER ANDROID™, BLACKBERRYR OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The present disclosure provides a user-friendly approach for facilitating real-time data availability.

In an embodiment, the present disclosure eliminates requirement for third party plugins for facilitating data availability.

In an embodiment, real-time graphical dashboard and reporting capabilities are provided which makes data monitoring easy.

The present disclose facilitates efficient real-time data import and availability.

In an embodiment, a post-import data reflection validation is performed which enables traceability of data uploads.

The present disclosure takes place in real-time, thereby removing the requirement of performing a synchronization procedure.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include e suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself

The illustrated operations of FIGS. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for facilitating real-time data availability in enterprises, the method comprising:
receiving, by a data management system, user data, associated with an enterprise from a user;
performing, by the data management system, a first level of validation of the user data based on pre-defined data governance standards of the enterprise;
performing, by the data management system, a second level of validation of the first level validated user data, based on pre-defined data integrity rules and taxonomy rules and standards, associated with the enterprise;
uploading, by the data management system, the second level validated user data on a customer relation management database associated with the enterprise; and
validating, by the data management system, the uploaded data based on the pre-defined data governance standards, the data integrity rules, the taxonomy rules, and the standards associated with the enterprise, to facilitate real-time data availability in the enterprise.

2. The method as claimed in claim 1, wherein the user data is received in service request template, said service request template comprises at least one of mandatory fields or optional fields.

3. The method as claimed in claim 1, wherein the pre-defined data governance standards comprises at least one of a completeness check, conformity check, field duplicate check or reference check associated with the user data.

4. The method as claimed in claim 1, wherein the pre-defined data integrity rules and the taxonomy rules and standards comprises at least one of system integrity check, de-duplicate check or user access check.

5. The method as claimed in claim 1, wherein validating the uploaded data comprises, verifying whether the uploaded data is reflected correctly in the customer relation management database.

6. The method as claimed in claim 5 further comprising performing a rollback operation on the uploaded data on identifying one or more anomalies in the uploaded data.

7. The method as claimed in claim 1 further comprising generating a transaction summary report, wherein the translation summary report comprises a status of the user data uploaded in the customer management server and the user data which failed at least one of the first level of validation, the second level of validation or the uploaded data validation, along with error descriptions.

8. A data management system for facilitating real-time data availability in enterprises, comprising:
a processor; and
a memory communicatively coupled to the processor, wherein the memory stores processor instructions, which, on execution, causes the processor to:
receive user data, associated with an enterprise from a user;
perform a first level of validation of the user data based on pre-defined data governance standards of the enterprise;
perform a second level of validation of the first level validated user data, based on pre-defined data integrity rules and taxonomy rules and standards, associated with the enterprise;
upload the second level validated user data on a customer relation management database associated with the enterprise; and
validate the uploaded data based on the pre-defined data governance standards, the data integrity rules, the taxonomy rules, and the standards associated with the enterprise, to facilitate real-time data availability in the enterprise.

9. The data management system as claimed in claim 8, wherein the user data is received in service request template, said service request template comprises at least one of mandatory fields or optional fields.

10. The data management system as claimed in claim 8, wherein the pre-defined data governance standards comprises at least one of a completeness check, conformity check, field duplicate check or reference check associated with the user data.

11. The data management system as claimed in claim 8, wherein the pre-defined data integrity rules and the taxonomy rules and standards comprises at least one of system integrity check, de-duplicate check or user access check.

12. The data management system as claimed in claim 8, wherein the processor validates the uploaded data by verifying whether the uploaded data is reflected correctly in the customer relation management database.

13. The data management system as claimed in claim 12, wherein the processor performs a rollback operation on the uploaded data on identifying one or more anomalies in the uploaded data.

14. The data management system as claimed in claim 8, wherein the processor generates a transaction summary report, wherein the translation summary report comprises a status of the user data uploaded in the customer management server and the user data which failed at least one of the first level of validation, the second level of validation or the uploaded data validation, along with error descriptions.

15. A non-transitory computer readable medium including instruction stored thereon that when processed by at least one processor cause a data management system to perform operation comprising:
receiving user data, associated with an enterprise from a user;
performing a first level of validation of the user data based on pre-defined data governance standards of the enterprise;
performing a second level of validation of the first level validated user data, based on pre-defined data integrity rules and taxonomy rules and standards, associated with the enterprise;
uploading the second level validated user data on a customer relation management database associated with the enterprise; and
validating the uploaded data based on the pre-defined data governance standards, the data integrity rules, the taxonomy rules, and the standards associated with the enterprise, to facilitate real-time data availability in the enterprise.

16. The medium as claimed in claim 15, wherein the user data is received in service request template, said service request template comprises at least one of mandatory fields or optional fields.

17. The medium as claimed in claim 15, wherein the pre-defined data governance standards comprises at least one of a completeness check, conformity check, field duplicate check or reference check associated with the user data.

18. The medium as claimed in claim 15, wherein the pre-defined data integrity rules and the taxonomy rules and standards comprises at least one of system integrity check, de-duplicate check or user access check.

19. The medium as claimed in claim 15, wherein validating the uploaded data comprises, verifying whether the uploaded data is reflected correctly in the customer relation management database.

20. The medium as claimed in claim 19, wherein the instruction causes the processor to perform a rollback operation on the uploaded data on identifying one or more anomalies in the uploaded data.

21. The medium as claimed in claim 15, wherein the instruction causes the processor to generate a transaction summary report, wherein the translation summary report comprises a status of the user data uploaded in the customer management server and the user data which failed at least one of the first level of validation, the second level of validation or the uploaded data validation, along with error descriptions.
